(19) United States
(12) Patent Application Publication
(10) Pub. No.: US 2025/0170518 A1
(43) Pub. Date: May 29, 2025

(54) METHOD OF PRODUCING CARBON DIOXIDE FROM A GAS SCRUBBING PROCESS

(71) Applicant: ESTECH A/S, Svendborg (DK)

(72) Inventors: Jan Stougaard JAKOBSEN, Svendborg (DK); Jacob Lindner BONDE, Svendborg (DK)

(73) Assignee: ESTECH A/S, Svendborg (DK)

(21) Appl. No.: 18/840,651

(22) PCT Filed: Mar. 3, 2023
(86) PCT No.: PCT/EP2023/055416

§ 371 Date: Aug. 22, 2024

(30) Foreign Application Priority Data
Mar. 4, 2022 (EP) 22160299.8

(51) Int. Cl. B01D 53/14; B01D 53/00; B01D 53/18; B01D 53/62; B01D 53/73; B01D 53/78; B01D 53/96; C01B 32/50; C02F 3/02

(52) U.S. Cl. CPC B01D 53/1418; B01D 53/005; B01D 53/1425; B01D 53/1475; B01D 53/18; B01D 53/62; B01D 53/73; B01D 53/78; B01D 53/965; C01B 32/50; C02F 3/02; B01D 2251/202; B01D 2256/22; B01D 2257/104; B01D 2257/504; B01D 2258/0283; B01D 2258/06

(57) ABSTRACT

There is a method for preparing a substantially pure gaseous carbon dioxide from a gaseous mixture of carbon dioxide (CO₂) and oxygen (O₂). The gaseous mixture is withdrawn from an anode chamber of an electrolytic cell. The electrolytic cell is fed a spent aqueous scrubbing liquid from a scrubber. The scrubber scrubs a gas [having a first carbon dioxide concentration] with a first alkaline, aqueous scrubbing liquid. The spent aqueous scrubbing liquid is regenerated in the electrolytic cell by electrolysis. Regeneration further has the step of generating a gaseous mixture of oxygen and carbon dioxide in the anode chamber The gaseous mixture has between 66 and 80% carbon dioxide and between 20% and 34% oxygen. The method has the step of treating said gaseous mixture of oxygen and carbon dioxide to remove at least 50% oxygen from said mixture.

### CROSS REFERENCE TO RELATED APPLICATION

This application is a national stage application under 35 U.S.C. § 371, of PCT/EP2023/055416, filed on Mar. 3, 2023 and which claims the benefit under 35 U.S.C. § 119 (a) of European Application No. 22160299.8 filed on Mar. 4, 2022, the contents of both are incorporated by reference herein in their entirety.

### FIELD OF THE DISCLOSURE

The present disclosure relates to a method of producing a substantially pure gaseous carbon dioxide (CO₂), by separating gaseous mixture of carbon dioxide (CO₂) and oxygen (O₂) after an electrolytic regeneration of a spent aqueous scrubbing liquid from a process of scrubbing a gas, such as flue gas comprising carbon dioxide. The substantially pure carbon dioxide is then compressed to a liquid CO₂ for transport. The CO₂ may be extracted from flue gas, ambient air or other sources.

### DESCRIPTION OF THE RELATED ART

Carbon dioxide (CO₂) is a gas that when emitted into the atmosphere is damaging to the climate as it contributes to the green-house effect and rise in global temperature. It is for example produced as a by-product when fossil fuel, e.g. coal, gasoline or diesel, is burned. Coal- and gas-fired power plants accounts for a large share of CO₂ emissions. It is a goal for many sectors to lower carbon dioxide emissions.

Emitted gases resulting from combustion and comprising CO₂ are typically denoted flue gases or exhaust gases. Depleting such emitted gases of CO₂ by lowering the CO₂ content in the emitted gases, can be done by so called scrubbing of the gases, i.e. removing the CO₂ from the gas stream by absorbing/dissolving CO₂ in a liquid.

As described in U.S. Pat. No. 11,219,860, the CO₂ withdrawn from the scrubbing process, or from an anode chamber of an electrolytic cell, after regeneration of a scrubbing liquid, is then conventionally compressed, or cooled and compressed to be transported of site for other downstream uses. However, the process of cooling and compressing gaseous CO₂ into a liquid carbon dioxide requires a substantial amount of power. There is an imperative need for improved scrubbing systems that preferably require less power for the CO₂ capture and compression. The method in accordance with the present disclosure, may be obtained using the method and system disclosed in U.S. Pat. No. 11,219,860.

### SUMMARY OF THE DISCLOSURE

It is in view of the above considerations and others that the embodiments described in this disclosure have been made. It is an object of the present disclosure, to provide an improved method of preparing a substantially pure gaseous carbon dioxide, and a system and uses thereof.

The disclosure is defined by the appended independent claims. Embodiments are set forth in the appended dependent claims and in the following description.

Accordingly, there is provided a method of preparing a substantially pure gaseous carbon dioxide from a gaseous mixture of carbon dioxide (CO₂) and oxygen (O₂), wherein said gaseous mixture is withdrawn from an anode chamber of an electrolytic cell, and wherein said electrolytic cell is fed a spent aqueous scrubbing liquid from a scrubber, wherein said scrubber scrubs a gas, having a first carbon dioxide concentration with a first alkaline, aqueous scrubbing liquid, wherein said spent aqueous scrubbing liquid is regenerated in the electrolytic cell by electrolysis, wherein the regeneration further comprises generating a gaseous mixture of oxygen and carbon dioxide (CO₂) in the anode chamber; and wherein said gaseous mixture comprises between 66 and 80% v/v carbon dioxide and between 20% v/v and 34% v/v oxygen, the method comprising the steps of: treating said gaseous mixture of oxygen and carbon dioxide (CO₂) to remove at least 50% oxygen from said mixture.

The aqueous scrubbing liquid may be circulated between the electrolytic cell and the scrubber, where the scrubbing liquid may be a first alkaline, where a first spent aqueous scrubbing liquid is fed to an electrolytic cell, and a first regenerated aqueous scrubbing liquid is fed back to the scrubber from the electrolytic cell, after regeneration in the electrolytic cell. The treatment of the gaseous mixture of oxygen and carbon dioxide to remove oxygen from said mixture may be performed using a gas separator device, where the gas separator device may be a sorbent/solvent gas separator, a membrane separator and/or a cryogenic distillation separator, or any suitable method/device for treating the stream to separate O₂ from a CO₂ rich stream and create a CO₂ rich stream that has a reduced O₂ content.

The regeneration of the scrubbing liquid in the electrolytic cell results in a generation of a gaseous mixture of oxygen and carbon dioxide

This means that at least a substantial amount of oxygen is removed from the mixture. By removing oxygen, i.e. separating O₂ from the CO₂ of the gaseous mixture form the anode chamber of the electrolytic cell, an increased efficiency is obtained in the CO₂ compression stage. The decrease in efficiency correlates with decrease in gas volume that is to be compressed. e.g. if there is 20% v/v O₂ in 80% v/v CO₂ the energy consumption can be reduced to 80% of the original value.

The carbon capture reaction in the scrubbing step takes place automatically. The operation of the scrubber is thereby an automatic process and requires no power apart from one needed to circulate the liquids. The regeneration process of the first scrubbing liquid that take place in the cathode and anode chambers of the electrolytic cell are electrochemical reactions, which inherently require electrical power. The electrochemical process regenerates the solvent, produces hydrogen at the cathode and a mixture of carbon dioxide (CO₂) and oxygen at the anode. The regeneration thus comprises generating gaseous hydrogen in the cathode chamber and a gaseous mixture of oxygen and carbon dioxide in the anode chamber by electrolysis.

In accordance with the present disclosure the percentages of concentrations of liquids or gas may be defined by % v/v i.e. a volume concentration of a solution, where a solution having 80% CO₂ and 20% O₂ may be seen as a solution of 100 units of a volume, has 80 units of CO₂ and 20 units O₂, where the units may be ml, litres,

According to the first aspect wherein at least 60% of the oxygen is removed from the gaseous mixture, or at least 70% of the oxygen is removed from the gaseous mixture, or at least 80% of the oxygen is removed from the gaseous mixture, or at least 90% of the oxygen is removed from the gaseous mixture, or at least 95% of the oxygen is removed from the gaseous mixture, or at least 99% of the oxygen is removed from the gaseous mixture. This means that substantially all of the oxygen may be removed before compression, which even further increased the energy saved during the compression stage.

According to the first aspect, the method may further comprise the step of compressing said oxygen depleted gaseous mixture into a substantially pure liquid carbon dioxide. This means that the liquid carbon may easily be transported for other downstream uses. The gas having a first carbon dioxide concentration is any one of a flue gas, an exhaustive gas, air.

According to one alternative of the first aspect wherein the step of treating said gaseous mixture to remove at least 50% oxygen from said mixture comprises: flowing said gaseous mixture through a heating device, thereby consuming said oxygen and creating an output flow of carbon dioxide and dihydrogen oxide (H₂O). The heating device may be a separate burner, or for instance a generator producing district heating and power, and the full flow of the gaseous mixture of carbon dioxide and oxygen could be used instead of air. The carbon dioxide and water may thus be further separated by condensation, and the pure CO₂ can be further cleaned, cooled and compressed for transport.

The heating device may be fed with a fuel, and wherein said fuel is any one of hydrogen, natural gas or biogas and said hydrogen may be a gaseous hydrogen withdrawn from a cathode chamber of said electrolytic cell.

According to another alternative of the first aspect, the step of treating said gaseous mixture to remove at least 50% oxygen from said mixture may comprise utilising said gaseous mixture as an oxidizer in a processes step of scrubbing a flue gas for CO₂.

Through this treatment, if all the oxidant is oxygen mixed with carbon dioxide, the flue gas will intermittently consist of pure CO₂, which can thus be cooled and compressed directly for transport with limited pre-treatment.

According to yet another alternative of the first aspect the step of treating said gaseous mixture to remove at least 50% oxygen from said mixture comprises utilising said gaseous mixture as an oxidizing agent in an aerobic biological treatment process.

By an aerobic biological treatment process is meant for instance a wastewater purification process, and through this treatment the oxygen is depleted during the wastewater purification process and the purified CO₂ can be collected, cooled and compressed for transport.

According to a second aspect there is provided a system for scrubbing a gas, such as flue gas or exhaustive gas, comprising carbon dioxide to deplete the flue gas of carbon dioxide, the system comprising:
a scrubber arrangement for scrubbing a gas with an alkaline, aqueous scrubbing liquid, comprising a scrubber; and
a regeneration arrangement for regenerating spent aqueous scrubbing liquid by electrolysis, wherein:
the regeneration arrangement comprises an electrolytic cell, comprising an anode chamber comprising an anode inlet for receiving the spent aqueous scrubbing liquid and an anode outlet for withdrawing oxygen and carbon dioxide,
wherein the scrubber is in flow communication with the electrolytic cell;
a gas separator device for separating oxygen and carbon dioxide withdrawn from the anode chamber from each other, and
a compressor unit for compressing said substantially pure carbon dioxide withdrawn from said separator device.

According to a third aspect, a regeneration arrangement is provided for regenerating a spent aqueous scrubbing liquid to provide alkaline, aqueous scrubbing liquid, the regeneration arrangement comprising an electrolytic cell, comprising an anode chamber comprising an anode inlet for receiving the spent aqueous scrubbing liquid and an anode outlet for withdrawing oxygen and carbon dioxide, and the cathode chamber comprises an outlet for withdrawing regenerated aqueous scrubbing liquid;
a gas separator device for separating oxygen and carbon dioxide from the anode chamber from each other,
a compressor unit for compressing carbon dioxide withdrawn from the first gas separator.

According to one alternative of the systems according to the second or third aspect, the gas separator device may be a heating device. By heating device is meant a device such as a burner, an engine or a generator.

According to another alternative, the gas separator device may be an aerobic biological process facility such as a wastewater treatment plant.

According to the second and third aspects, at least 50% of the oxygen is removed from the gaseous mixture of carbon dioxide and oxygen withdrawn from the anode chamber by or in the gas separator device. Alternatively, at least 60% of the oxygen is removed from the gaseous mixture, or at least 70% of the oxygen is removed from the gaseous mixture, or at least 80% of the oxygen is removed from the gaseous mixture, or at least 90% of the oxygen is removed from the gaseous mixture, or at least 95% of the oxygen is removed from the gaseous mixture, or at least 99% of the oxygen is removed from the gaseous mixture.

Although the present disclosure has been described above with reference to specific embodiments, it is not intended to be limited to the specific form set forth herein. Rather, the disclosure is limited only by the accompanying claims and other embodiments than the specific embodiments described above are equally possible within the scope of these appended claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

### BRIEF DESCRIPTION OF THE DRAWINGS

These and other aspects, features and advantages of which the disclosure is capable of will be apparent and elucidated from the following description of embodiments of the present disclosure, reference being made to the accompanying drawings.

FIG. 1 shows a flow path between a scrubber and an electrolytic cell,

FIG. 2 shows a regeneration arrangement of the process scheme,

FIG. 3 shows a Voltage/Current graph for an electrolytic cell, and

FIG. 4 shows a graph showing the CO₂ concentration in volume percentage of a CO₂ mixture stream exiting the electrolytic cell.

### DETAILED DESCRIPTION OF THE DISCLOSURE

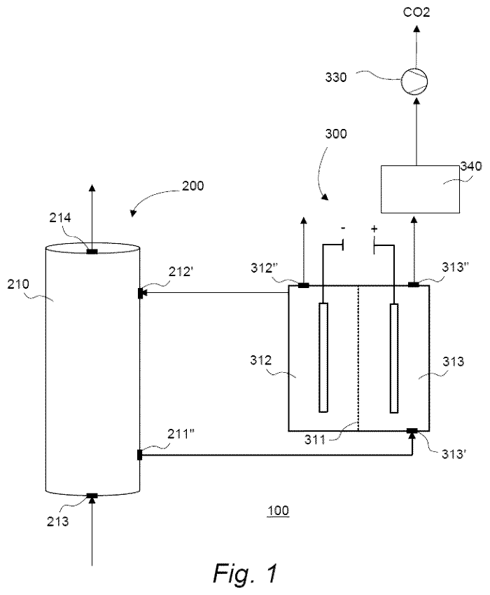

With reference to FIG. 1, a system 100 according to an embodiment is shown having a scrubber arrangement 200 and a regeneration arrangement 300. Here, a method of scrubbing a gas, such as flue gas or an exhaustive gas, comprising carbon dioxide CO₂, is schematically illustrated. The scrubber arrangement 200 and the regeneration arrangement 300, may be operated independently.

The gas which is scrubbed in the scrubber may for instance be a flue gas or an exhaustive gas. One alternative is to utilise the scrubber and regeneration in a vehicle. Another option could be so called DAC (direct air capture) applications, where CO₂ is captured from the ambient air and a stream of concentrated CO₂ is generated. The gas enters the scrubber through the scrubber inlet 213. To deplete the flue gas from carbon dioxide CO₂, the scrubbing method can be described as follows. The gas is scrubbed in the scrubber 210 in a counter flow manner with a first alkaline, aqueous scrubbing liquid to dissolve carbon dioxide CO₂ as hydrogen carbonate HCO₃— and/or as carbonate CO₃²— in the first alkaline, aqueous scrubbing liquid. A first spent aqueous scrubbing liquid comprising dissolved hydrogen carbonate HCO₃— and/or carbonate CO₃²— results. The first spent aqueous scrubbing liquid has a pH from about 7 to about 11, or usually from about 7 to about 9, when it leaves at the outlet 211″ for withdrawing spent aqueous scrubbing liquid of the scrubber 210. The first spent aqueous scrubbing liquid is then fed to an anode chamber 313 of an electrolytic cell 310 via an anode inlet 313′. The electrolytic cell 310 has apart from the anode chamber 313 also a cathode chamber 312. The anode chamber 313 and the cathode chamber 312 are separated by a membrane 311. This membrane 311 may be semi-permeable membrane, being permeable to cations, but essentially impermeable to anions. Thus, the membrane cation-exchange membrane. The electrolysis increases the pH of the first spent aqueous scrubbing liquid in the cathode chamber 312. In the anode chamber 313, the electrolysis further depletes the first spent aqueous scrubbing liquid of hydrogen carbonate HCO₃— and of carbonate CO₃²— by decreasing the pH-value to release gaseous carbon dioxide. The outlet 211″ for spent aqueous scrubbing liquid of the scrubber 210 is in flow communication with the inlet 313′ for the spent aqueous scrubbing liquid of the anode chamber 313. Moreover, the outlet 312″ for regenerated aqueous scrubbing liquid of the cathode chamber 312 is flow communication with the inlet 212′ for the alkaline, aqueous scrubbing liquid of the scrubber 210.

One can say that the first spent aqueous scrubbing liquid is regenerated by generating gaseous hydrogen H₂ and dissolved hydroxide ions OH⁻ in the cathode chamber 312 and a gaseous mixture of oxygen O₂ and carbon dioxide CO₂ in the anode chamber 313 by electrolysis. This is indicated by the upwards pointing arrows from the cathode outlet 312″ and the anode outlet 313″ in FIG. 1, respectively. The gaseous hydrogen H₂ and dissolved hydroxide ions OH⁻ are withdrawn from the cathode chamber 312 and the gaseous mixture of oxygen O₂ and carbon dioxide CO₂ are withdrawn from the anode chamber 313. For instance, the hydrogen H₂ may be used in downstream processes (not shown) such as in fuel or methanol production. The regenerated alkaline, aqueous scrubbing liquid from the cathode chamber 312 is then recirculated via the inlet 212′ for receiving the alkaline, aqueous scrubbing liquid to the scrubber 210. Gas depleted of carbon dioxide CO₂ then exits the scrubber 210 via the scrubber outlet 214.

The gaseous mixture of carbon dioxide and oxygen withdrawn from the anode chamber 313 is transported to a separation device 340, where oxygen is removed from the gaseous mixture, such that a stream of substantially pure gaseous CO₂ is obtained. The substantially pure gaseous CO₂ may then be transferred to a compression unit 330, where the gaseous CO₂ is converted into a substantially pure liquid CO₂.

Furthermore, the regeneration arrangement 300 also comprises a first gas separator device 340 for separating oxygen O₂ and carbon dioxide CO₂ withdrawn from the anode chamber 313 from liquid. The first gas separator 340 is arranged upstream the second compressor unit 330.

The composition of the gaseous mixture is typically around 75% v/v CO₂ and 25% v/v O₂. When the system 100 operates, the oxygen O₂ and carbon dioxide CO₂ are separated in the first gas separator device 340 leaving a substantially pure gaseous CO₂ stream which may be compressed in the first compressor unit 330. An advantage of providing CO₂ in a liquid phase is that it is practical during transportation. According to the disclosure oxygen is thus removed from the gaseous mixture before the carbon dioxide is compressed.

According to the disclosure oxygen is thus removed from the gaseous mixture before the carbon dioxide is compressed.

At least 50% of the oxygen is removed from the gaseous mixture, as this allows for a substantial energy saving when compressing the carbon dioxide into a liquid carbon dioxide.

According to an alternative embodiment least 60% of the oxygen is removed from said mixture.

According to one embodiment at least 80% of the oxygen is removed from said mixture.

According to one embodiment at least 90% of the oxygen is removed from said mixture.

According to one embodiment at least 95% of the oxygen is removed from said mixture.

According to one embodiment at least 99% of the oxygen is removed from said gaseous mixture.

The gas separator device 340 may according to one embodiment may be a heating device. The heating device may for instance be a burner where the oxygen in the gaseous mixture is used as an oxygen source instead of air, leaving a pure CO₂ steam of gas and water which can be collected, cleaned and handled downstream of the separator device. The heating device may also be a generator, such as for instance for obtaining central or district heating and power, using either biogas, natural gas or H₂ gas as input and the full flow from the anode chamber outlet of the gaseous mixture of CO₂/O₂ is used as an oxygen source. One alternative is to use the H₂ gas from the cathode chamber of the electrolyser cell as input.

According to another embodiment, the separator device 340 provides the gaseous mixture of carbon dioxide and oxygen as an oxidizer or oxidizing agent in the process where the gas is scrubbed for CO₂ if all the oxidant is O₂ mixed with CO₂ the flue gas will intermittently consist of pure CO₂ and it can thus be compressed directly with limited pre-treatment. As an example, a gas fired generator may be fueled with methane and a mixture of CO₂/O₂ instead of air, which leads to the exhaust gas being is pure CO₂ and water. The exhaust gas created is therefore pure CO₂, as no nitrogen from the air is injected creating NOx and N2 in the exhaust.

According to a third embodiment the separator device 340 is a biological aerobic process, such as for instance a wastewater treatment plant, which is either in flow connection to the regeneration arrangement, or where the gaseous mixture of oxygen and carbon dioxide is transported. The gaseous mixture is utilised in the wastewater treatment process, such that the oxygen in the gaseous mixture is consumed as an oxidizing agent, for instance through various enzymatic and bacterial reactions in the wastewater process. The purified CO₂ may then be collected and compressed.

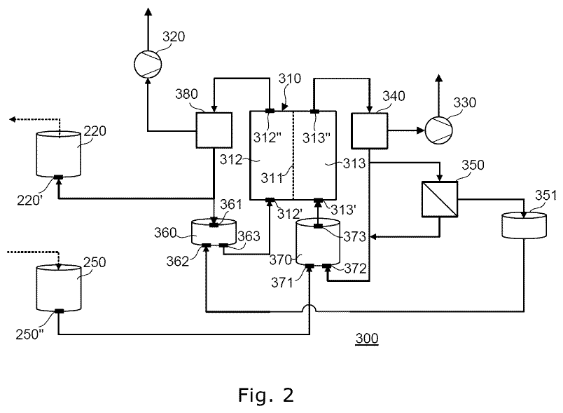

Now turning to the regeneration arrangement 300 in FIG. 2. Other than the electrolytic cell 310 and its components, which have been previously described in relation to FIG. 1, the regeneration arrangement 300 further comprises a second compressor unit 320 for compressing hydrogen gas withdrawn from the cathode chamber 312.

The regeneration arrangement 300 also comprises a second gas separator 380 for separating gaseous hydrogen H2 and, for instance, liquid aqueous potassium hydroxide KOH, withdrawn from the cathode chamber 312.

Furthermore, the regeneration arrangement 300 has a separator 350, such as a filter. For instance, the filter may be a reversed osmosis filter. This concentrator 350 is arranged downstream of the first gas separator unit 340. It is to be noted that the electrolytic cell may be sensitive to impurities in the fluid flowing through the anode and cathode chambers. Hence, there may also be a separate cleaning unit (not shown), which serves to remove impurities such as for instance nitrogen oxides NOx and sulfur oxides SOx from the spent aqueous scrubbing liquid before it enters the electrolytic cell 310. As an example, the cleaning unit may include a filter to remove particulate matter. It should be noted that in FIGS. 1-2, the direction of the arrows corresponds to the direction of flow of the fluids circulating in the system 100. Further, the lines of the arrows indicate a fluid or flow communication between the elements of the system.

### Chemical Processes

The solvent is then regenerated in the regeneration arrangement 300 using electrochemistry. In general, the electrochemical reaction can be split into two parts; the anode reaction and the cathode reaction. These reactions will be described below.

### The Anode

In the anode chamber 313, O₂ and CO₂ are generated in two different steps. First, O₂ is generated at the anode together with 4 H⁺. Then, the H+ decreases the pH-value of the solvent and releases CO₂. Simultaneously, O₂ is generated at the anode and the two gases are mixed in a ratio of 4:1, CO₂ to O₂. The overall reaction at the anode chamber 313 is:

4×HCO₃→O₂+4×CO₂+2×H₂O+4e⁻

The reaction at the anode is:

2×H₂O→O₂+4×H⁺+4e⁻

This reaction decreases the pH-value locally. This decrease in pH-value pushes the

HCO₃—/CO₂ equilibrium to the right, such that:

4×H⁺+4×HCO₃→4×CO₂+4×H₂O

which results in the release of gaseous CO₂ from the solvent.

### The Cathode

At the cathode, H₂ is produced together with OH. This reaction both generates valuable H₂ for downstream applications and regenerates the alkaline solvent comprising hydroxide ions (OH) for the carbon capture process. The cathode chamber reaction 312 is:

4×H₂O+4→2×H₂+4×OH⁻.

### Power Need

The electrochemical reaction in the electrolytic cell 310 requires electrical power. The actual power consumption will depend on the technical implementation of the process of the system 100. Assuming 100% efficiency, the minimum current required for the process can be calculated using Faraday's law of thermodynamics: I=mFz/tM. With the parameters as listed in Table 1 below, the current can be calculated.

TABLE 1
parameters for calculating the minimum
current required for the process

| Symbol | Quantity | Value | |
|---|---|---|---|
| m | Mass of O₂ | 182 | kg |
| F | Faraday's constant | 96485 | C/mol |
| z | Valency number of | 4 | |
| | electrons | | |
| t | Time | 1 | s |
| M | Molar mass of O₂ | 32 | g/mol |

The current can thus be calculated to I=2. 18×10⁹ A. With a minimum voltage of 2 V assumed, the theoretical minimum power consumption for 1 ton of CO₂ will be:

$${P}_{min} = 2 V \times 2.18 \times 1 {0}^{9} A = 2.18 \times 109 J = 4.36 GJ .$$

For real chemical reactions, a higher energy consumption is expected. As suggested by a model based on experiments the ultimate power consumption for the capture of CO₂ and regeneration of the solvent is predicted to 5.88 GJ per 1 ton of CO₂. This process regenerates the solvent, produces H₂ at the cathode 312 and a mixture of CO₂ and O₂ at the anode. Further energy is required for the separation of the CO₂ and O₂ from the first gas separator 340.

CO₂ and H₂ is typically produced in a ratio of 2:1. If the downstream application is methanol production, the suitable stoichiometric ratio is 1:3 and additional H₂ is required for this process. Commercial electrolysis equipment produces H₂ with an energy consumption of 55 kWh/kg. For 1 ton of CO₂, the H₂ requirements are therefore (m_{co2}M_{co2})×3=68182 mol, which equals: 68182 mol×2 g/mol×55 kWh/kg=7500 kWh=26.98 GJ. The carbon capture regeneration process produced H₂ corresponding to 4.5 GJ, and the remaining energy requirements for H₂ production is therefore: 26.98 GJ−4.50 GJ=22.48 GJ. The power consumption of the carbon capture process is determined primarily by the electrochemical cell. The purification of CO₂ requires additional energy.

Efficiency Gain in CO₂ Compressor when CO₂ is Removed from the Gas Stream.

The liquefaction or compression of CO₂ requires energy, where the energy may be in the form of electricity for a compressor. Typically, CO₂ is transported in its liquid state at 15 bars and −30 C. The optimized compression and liquefaction of pure CO₂ typically has an energy cost of app. 110 wh/kg CO₂. If other components are present in the CO₂ the cost of compression will increase due to increased volume and weight.

The CO₂ stream exiting system 100 according to the present disclosure may contain a CO₂ and O₂ mixture with a CO₂ content between 66% v/v and 80% v/v, thus the energy required to compress the CO₂ stream will be higher than that of pure CO₂.

Tests and calculations performed based on a diabatic compression and subsequent condensation shows that the optimal energy requirement for compressing a CO₂ mixture stream having both CO₂ and O₂, where the content of CO₂ is around 80% v/v and O₂ is approximately 20% v/v, is approximately 160 wh/kg CO₂. Thus the 20% v/v O₂ in the CO₂ mixture stream increases the energy consumption from approximately 110 wh/kg CO₂ to 160 wh/kg CO₂, which is an increase of at least 50 wh/kg.

Thus, a reduction of the O₂ content of the CO₂ mixture stream will give a significant reduction in the energy usage, and thereby reduce the cost for compressing the CO₂ exiting the system 100 of the present disclosure.

### EXPERIMENTAL SECTION

### Example 1

In the following, a CO₂ capture from a power plant generating 10 MW heat and power from biomass is presented in relation to three process steps: “scrubber”, “regeneration” and “separation”. Overall, the process requires a large amount of electrical energy. This is positive, as electrification of the carbon capture process is highly wanted and completely new. Some of the energy may be recovered as heat for district heating.

TABLE 2
10 MW power plant CO₂ capture

| Process | Scrubber | Regeneration | Separation |
|---|---|---|---|
| In | Gas with ~10% CO₂ | Saturated liquid | Gas: 80% v/v CO₂ |
| | 2 ton CO₂/h | 400 m³/h | and 20% v/v O₂ |
| | Lean liquid | Power 3.2 MW | 2 ton/h CO₂ |
| | 400 m³/h | | Power 0.76 MW |
| | | | (Compression/ |
| | | | cooling without |
| | | | pre-separation) |
| | | | 0.61 MW (With |
| | | | CO₂ pre- |
| | | | seperation) |
| Out | Gas without CO₂ | Lean liquid | Gas: pure CO₂ |
| | Saturated liquid | 400 m³/h | 2 ton/h CO₂ |
| | 400 m³/h | Gas: H₂ 45 kg/h | |
| | | Gas: 80% v/v CO₂ | |
| | | and 20% v/v O₂ | |
| | | 2 ton/h CO₂ | |
| Opera- | Automatic | Uses power | Uses power |
| tion | process | | |

### Example 2

To verify the applicability of the process using the system 100 as described herein, laboratory tests have been performed.

In the laboratory tests, a standard electrolysis cell from EC Electrocell, model Electro MP Cell was used. The electrolysis cell was provided with a Nafion 117 membrane. In operating the cell, a 1,5 M KHCO₃ solution was circulated over the anode side from a combined degassing/circulation tank. The liquid was circulated at 1.5 L/min. Similarly, a 1.5 M KOH solution was circulated over the cathode side from a combined degassing/circulation tank. The liquid was circulated at 1.5 L/min. Standard flowmeters and lab pumps were used. Gas flow from the degassing tanks were measured by an Aalborg GFM gas flow meter. CO₂ contents were measured using a Guardian NG from Edinburgh Sensors. A standard heat plate was used to keep a constant temperature of the liquid at 40 degrees Celsius during the experiments. The pH and temperature were measured in the circulation tanks using standard online pH and temperature meters. The current density applied to the electrolyser were varied between 1-4 kA/m², using a standard power converter.

### Example 3

Details with Data from Single Cell Tests

To verify the applicability of the process using system 100 as described herein, tests have been performed. The test was performed on commercially available components from Electrocell that typically is used for KOH and chlorine production. The cell was of the type Electro MP Cell, from Electrocell A/S, Vennelystvej 1, DK-6880 Tarm, with the following configuration, the anode being titanium coated with MMO, the cathode being out of a Nickel alloy and the membrane being a Nafion 424 membrane.

The test was performed on a 0.6 M KHCO₃ solution that is equivalent to absorber liquid that is fully loaded with CO₂, the absorber liquid is circulated on the anode side of the cell with 1.5 l/min. The CO₂ content of the absorber liquid is dependent on the effectiveness of the Scrubber, and where the tests have been performed the absorber liquid had absorbed at least 90% of possible CO₂ absorption possible by the absorption liquid.

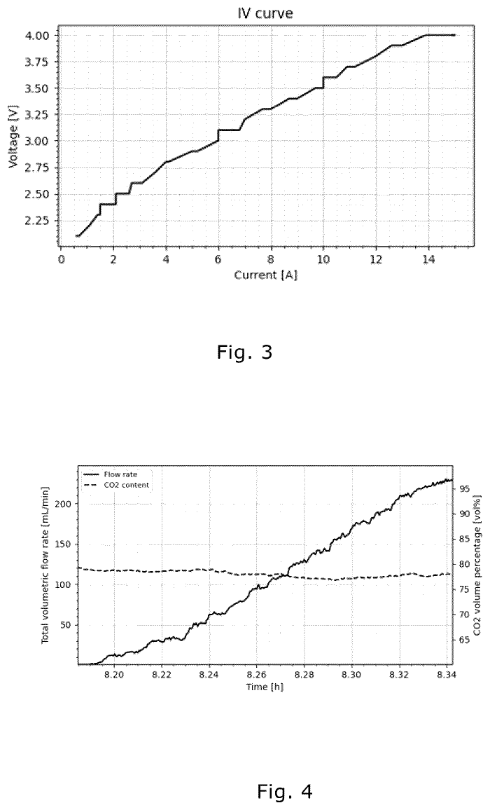

On the Cathode a 4.5 M KOH is circulated with 1.5 l/min, and the KOH concentration is increased, bleeding out liquid from the cathode is equivalent to lean absorber liquid. The temperature of the cell and liquid streams is set to 70 C. A voltage is then applied to the cell and increased until a current of 15 A is reached, for full current voltage relation of the cell, as seen in FIG. 3.

The amount of CO₂ released from the anode is measured with a mass flow meter and CO₂ sensor, as seen in FIG. 4, which shows the CO₂ concentration and the gas flow as a function of time during the current voltage (4V at 15 A) curve performed. The flow meter used is of the type of Aalborg GFM gas flow meter and the CO₂ meter used is of the type Guardian NG from Edinburgh Sensors. Here it may be seen that the CO₂ mixture stream has a CO₂ content of about 78% v/v.

1. A method of preparing a substantially pure gaseous carbon dioxide from a gaseous mixture of carbon dioxide (CO₂) and oxygen (O₂), comprising:
(a) withdrawing said gaseous mixture of carbon dioxide (CO₂) and oxygen (O₂) from an anode chamber of an electrolytic cell,
(b) feeding a spent aqueous scrubbing liquid from a scrubber tosaid electrolytic cell, wherein said scrubber scrubs a gas having a first carbon dioxide concentration with a first alkaline, aqueous scrubbing liquid, wherein said spent aqueous scrubbing liquid is regenerated in the electrolytic cell by electrolysis;
(c) generating a gaseous mixture of oxygen (O₂) and carbon dioxide (CO₂) in the aid anode chamber during regeneration, wherein said gaseous mixture comprises between 66 and 80% v/v carbon dioxide (CO₂) and between 20% v/v and 34% v/v oxygen (O₂); and
(d) treating said gaseous mixture of oxygen and carbon dioxide (CO₂) to remove at least 50% oxygen from said gaseous mixture.

2. The method according to claim 1, wherein at least 60% of the oxygen is removed from said gaseous mixture.

3. The method according to claim 1, further comprising compressing said oxygen depleted gaseous mixture into a substantially pure liquid carbon dioxide.

4. The method according to claim 1, wherein the gas having a first carbon dioxide concentration is any one of a flue gas, an exhaustive gas, and air.

5. The method according to claim 1, wherein the treating said gaseous mixture to remove at least 50% oxygen from said gaseous mixture comprises: flowing said gaseous mixture through a heating device, thereby consuming said oxygen and creating an output flow of carbon dioxide and dihydrogen oxide (H₂O).

6. The method according to claim 5, wherein said heating device is fed with a fuel, and wherein said fuel is any one of hydrogen, natural gas or biogas.

7. The method according to claim 5, wherein said hydrogen is a gaseous hydrogen withdrawn from a cathode chamber of said electrolytic cell (313).

8. The method according to claim 1, wherein the treating of said gaseous mixture to remove at least 50% oxygen from said gaseous mixture comprises: utilizing said gaseous mixture as an oxidizer in a processes step of scrubbing a flue gas for CO₂.

9. The method according to claim 1, wherein the treating of said gaseous mixture to remove at least 50% oxygen from said gaseous mixture comprises: utilizing said gaseous mixture as an oxidizing agent in an aerobic biological process facility.

10. A system for scrubbing a gas, such as flue gas or exhaustive gas, comprising carbon dioxide to deplete the flue gas of carbon dioxide, comprising:
a scrubber arrangement for scrubbing a gas with an alkaline, aqueous scrubbing liquid, comprising a scrubber; and
a regeneration arrangement for regenerating spent aqueous scrubbing liquid by electrolysis, wherein: the regeneration arrangement comprises an electrolytic cell comprising: an anode chamber having an anode inlet for receiving the spent aqueous scrubbing liquid and an anode outlet for withdrawing oxygen and carbon dioxide, and wherein the scrubber is in flow communication with the electrolytic cell;
a gas separator device for separating oxygen and carbon dioxide withdrawn from the anode chamber from each other, and
a compressor unit for compressing said substantially pure carbon dioxide withdrawn from said separator device.

11. A regeneration arrangement for regenerating a spent aqueous scrubbing liquid to provide an alkaline, aqueous scrubbing liquid, comprising:
an electrolytic cell, comprising an anode chamber having an anode inlet for receiving the spent aqueous scrubbing liquid and an anode outlet for withdrawing oxygen and carbon dioxide, and a cathode chamber comprising an outlet for withdrawing regenerated aqueous scrubbing liquid;
a gas separator device for separating oxygen and carbon dioxide from the anode chamber from each other, and
a compressor unit for compressing carbon dioxide withdrawn from the first gas separator.

12. The system according to claim 10, wherein said gas separator device is a heating device.

13. The system according to claim 10, wherein said gas separator device is an aerobic biological process facility.

14. The system according to claim 10, wherein in said gas separator device at least 50% of the oxygen is removed from the gaseous mixture of carbon dioxide and oxygen withdrawn from the anode chamber.

15. The system according to claim 14, wherein at least 60% of the oxygen is removed from the gaseous mixture.

16. The method according to claim 2, wherein at least 70% of the oxygen is removed from the gaseous mixture.

17. The method according to claim 16, wherein at least 80% of the oxygen is removed from the gaseous mixture.

18. The method according to claim 17, wherein at least 90% of the oxygen is removed from the gaseous mixture.

19. The system according to claim 10, wherein at least 70% of the oxygen is removed from the gaseous mixture.

20. The system according to claim 19, wherein at least 80% of the oxygen is removed from the gaseous mixture.
